(19) United States
(12) Patent Application Publication
(10) Pub. No.: US 2026/0304484 A1
(43) Pub. Date: Oct. 1, 2026

(54) COLLISION HANDLING FOR MULTI-UNIVERSAL SUBSCRIBER IDENTITY MODULE DEVICE

(71) Applicant: MediaTek Singapore Pte. Ltd., Singapore (SG)

(72) Inventors: Ogeen Hanna Toma TOMA, Cambridge (GB); Tsang-Wei YU, Hsinchu City (TW); Hsuan-Li LIN, Hsinchu City (TW)

(21) Appl. No.: 19/477,258

(22) PCT Filed: Jul. 5, 2024
(86) PCT No.: PCT/CN2024/104092

§ 371 Date: Oct. 21, 2025

Related U.S. Application Data
(60) Provisional application No. 63/512,306, filed on Jul. 7, 2023.
(60) Provisional application No. 63/512,668, filed on Jul. 10, 2023.

(51) Int. Cl. H04W 74/0808; H04W 8/20; H04W 74/08

(52) U.S. Cl. CPC H04W 74/0825; H04W 8/20; H04W 74/0875

(57) ABSTRACT

Various solutions for collision handling for a multi-universal subscriber identity module (MUSIM) device are described. An apparatus may receive at least one configuration for at least one first-type gap and at least one second-type gap from a network. The apparatus may determine a plurality of collisions associated with occasions of the at least one first-type gap and the at least one second-type gap. The apparatus may perform a collision handling in an event that a keep solution is granted for certain of the collisions, wherein the collision handling comprises using a priority solution to handle one or more specific collisions among the collisions before using the keep solution to handle one or more remaining collisions among the collisions.

### CROSS REFERENCE TO RELATED PATENT APPLICATION(S)

The present disclosure is part of a non-provisional application claiming the priority benefit of U.S. Patent Application No. 63/512,306, filed 7 Jul. 2023 and U.S. Patent Application No. 63/512,668, filed 10 Jul. 2023, the contents of which herein being incorporated by reference in their entirety.

### TECHNICAL FIELD

The present disclosure is generally related to mobile communications and, more particularly, to collision handling for a multi-universal subscriber identity module (MUSIM) device.

### BACKGROUND

Unless otherwise indicated herein, approaches described in this section are not prior art to the claims listed below and are not admitted as prior art by inclusion in this section.

In wireless communications, such as mobile communications under the 3rd Generation Partnership Project (3GPP) standards including 5th Generation (5G) New Radio (NR) and 4th Generation (4G) Evolved Packet Service (EPS), when a user equipment (UE) implementation supports MUSIM (e.g., Subscriber Identity Module (SIM) #1 on network A and SIM #2 on network B), the UE can request MUSIM gap from network A to monitor activities of network B (e.g., paging, measurement, and system information (SI) reading). However, a collision, or overlap, between MUSIM gaps and measurement gaps (MGs) can cause unpredictable measurement performance for network A, and the UE would be required to handle such collisions. For example, when the number of colliding gaps is more than two and the colliding gaps comprise a mix of MUSIM gaps and MGs, as there is no proper collision handling mechanism specified in the current 3GPP specifications for such collision, it may lead to unpredictable UE behaviors and could impact the performance in network A and network B. Therefore, there is a need for a solution of collision handling for the foregoing situation in mobile communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issue pertaining to collision handling for a multi-universal subscriber identity module (MUSIM) device.

In one aspect, a method may involve an apparatus receiving at least one configuration for at least one first-type gap and at least one second-type gap from a network. The method may also involve the apparatus determining a plurality of collisions associated with occasions of the at least one first-type gap and the at least one second-type gap. The method may further involve the apparatus performing a collision handling in an event that a keep solution is granted for certain of the collisions, wherein the collision handling comprises using a priority solution to handle one or more specific collisions among the collisions before using the keep solution to handle one or more remaining collisions among the collision.

In one aspect, an apparatus may comprise a transceiver which, during operation, communicates wirelessly. The apparatus may also comprise a processor communicatively coupled to the transceiver. The processor, during operation, may perform operations comprising receiving, via the transceiver, at least one configuration for at least one first-type gap and at least one second-type gap from a network. Also, the processor may perform operations comprising determining a plurality of collisions associated with occasions of the at least one first-type gap and the at least one second-type gap. The processor may further perform operations comprising performing a collision handling in an event that a keep solution is granted for certain of the collisions, the collision handling comprises using a priority solution to handle one or more specific collisions among the collisions before using the keep solution to handle one or more remaining collisions among the collisions.

It is noteworthy that, although description provided herein may be in the context of certain radio access technologies, networks and network topologies such as LTE, LTE-Advanced, LTE-Advanced Pro, 5G, NR, 5G-Advanced, Internet-of-Things (IoT), Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting example scenarios of collision handling in accordance with an embodiment of the present disclosure.

FIG. 3 is a diagram depicting example scenarios of collision handling in accordance with another embodiment of the present disclosure.

FIG. 4 is a diagram depicting example scenarios of collision handling in accordance with still another embodiment of the present disclosure.

FIG. 5 is a diagram depicting example scenarios of collision handling in accordance with yet another embodiment of the present disclosure.

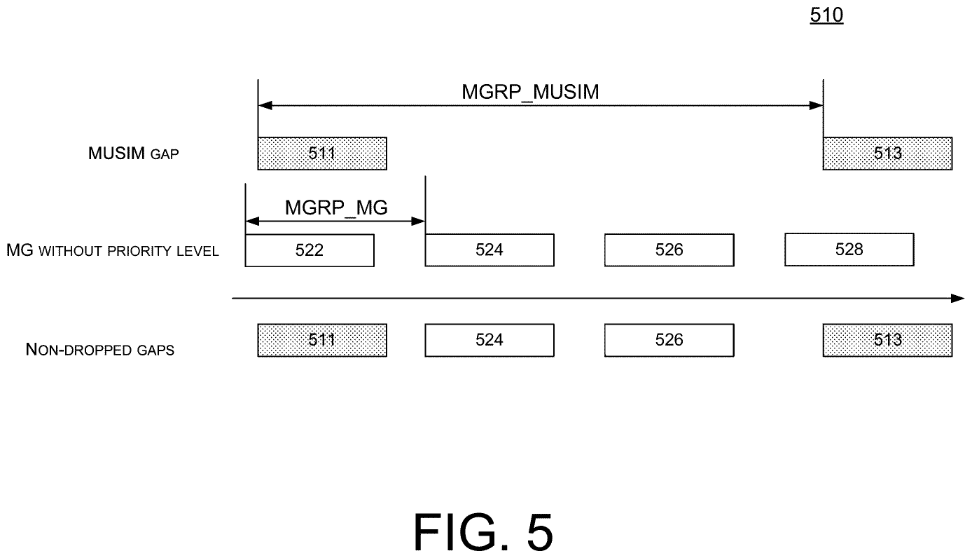

FIG. 6 is a block diagram of an example communication apparatus in accordance with an implementation of the present disclosure.

FIG. 7 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to collision handling for a multi-universal subscriber identity module (MUSIM) device. According to the present disclosure, a number of possible solutions may be implemented separately or jointly. That is, although these possible solutions may be described below separately, two or more of these possible solutions may be implemented in one combination or another.

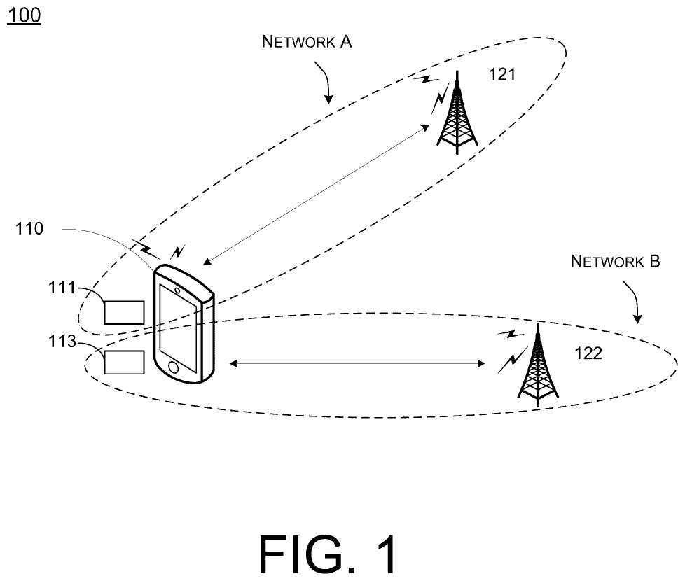

FIG. 1 illustrates an example scenario 100 of a communication environment in which various solutions and schemes in accordance with the present disclosure may be implemented. Scenario 100 involves a user equipment (UE) 110, a network A comprising a network device 121 and a network B comprising a network device 122. The UE 110 may be a smart phone, a wearable device, an IoT device, and a tablet, etc. The network devices 121 and 122 may be the base stations such as evolved NodeB (eNB), Next Generation Node B (gNB) and/or transmission/reception point (TRP).

In this embodiment, the UE 110 supports MUSIM, which carries a SIM 111 served by the network devices in the network A (e.g., the network device 121) and a SIM 113 served by the network devices in the network B (e.g., the network device 122).

The UE 110 can request up to four MUSIM gaps from the network A to monitor activities of the network B (e.g., paging, measurement, and system information (SI) reading). The UE 110 can also request measurement gap (MG) from network A. The MG can be Release 17 (Rel-17) concurrent MG, Pre-MG, or NCSG. The UE 110 may implement various schemes pertaining to collision handling in mobile communications in accordance with the present disclosure. Especially for handling the collision caused by more than two colliding gaps with a mix of gap types.

In the present disclosure, when the UE 110 is configured with gaps having different types (e.g., one or more MUSIM gaps and one or more MGs), in an event that the occasions of the configured MUSIM gap(s) and MG(s) are colliding and a keep solution is granted for certain of the collisions, the UE 110 first handles the collision(s) which a priority solution is granted for. Then, the UE 110 uses the keep solution to handle the remaining collision(s).

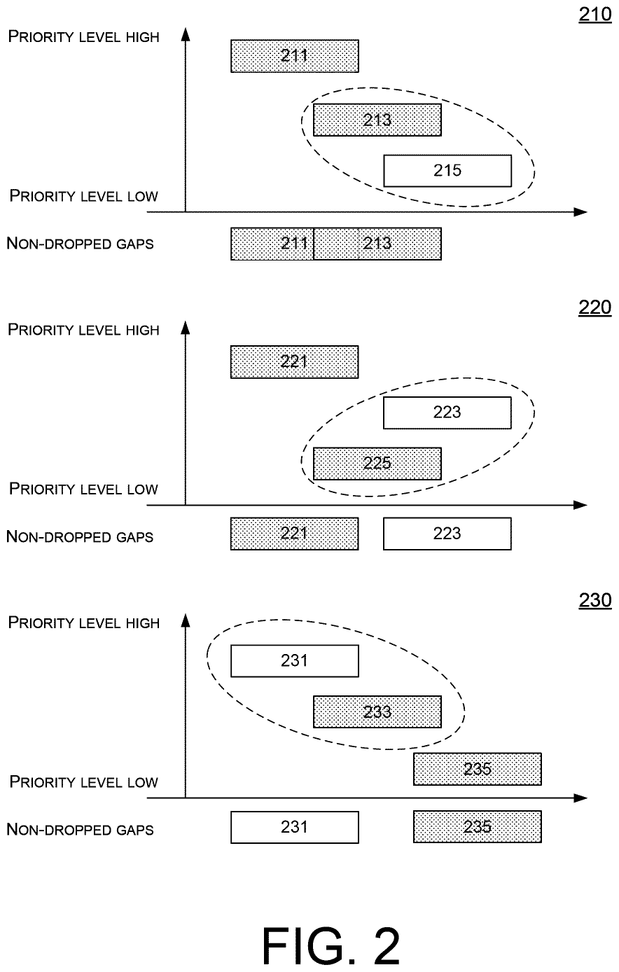

FIG. 2 is a diagram depicting example scenarios of collision handling in accordance with an embodiment of the present disclosure. In this embodiment, the UE 110 receives at least one configuration for two MUSIM gaps and one MG from the network A. The priority level of each of the MUSIM gaps and the MG is different and is configured by the network A. As shown in FIG. 2, the two MUSIM gap occasions and the MG occasion are colliding. In an event that a keep solution is granted for the collision between the two MUSIM gap occasions, the scenarios 210 to 230 show how the UE 110 perform a collision handling under the proposed scheme.

In scenario 210, the priority level of the MUSIM gap 211 is higher than that of the MUSIM gap 213, and the priority level of the MUSIM gap 213 is higher than that of the MG 215. Since a keep solution is granted for the collision between the occasion of the MUSIM gap 211 and the occasion of the MUSIM gap 213, the UE 110 first uses a priority solution for a collision associated with the occasion of the MG 215 to determine a non-dropped occasion. As the priority level of the MUSIM gap 213 is higher than that of the MG 215, the UE 110 determines the occasion of the MUSIM gap 213 as the non-dropped occasion (i.e., the occasion of the MUSIM gap 213 is kept and the occasion of the MG 215 is dropped). Then, the UE 110 uses the keep solution for the collision between the occasion of the MUSIM gap 211 and the occasion of the MUSIM gap 213, resulting in keeping the occasion of the MUSIM gap 211 and the occasion of the MUSIM gap 213.

In scenario 220, as a keep solution is granted for the collision between the occasion of the MUSIM gap 221 and the occasion of the MUSIM gap 225, the UE 110 first uses a priority solution for a collision associated with the occasion of the MG 223 to determine a non-dropped occasion. As the priority level of the MG 223 is higher than that of the MUSIM gap 225, the UE 110 determines the occasion of the MG 223 as the non-dropped occasion (i.e., the occasion of the MG 223 is kept and the occasion of the MUSIM gap 225 is dropped). Then, as the occasion of the MUSIM gap 211 is not colliding with the kept MG 223 occasion, the UE 110 determines the occasion of the MUSIM gap 211 as another non-dropped occasion, resulting in keeping the occasion of the MUSIM gap 211 and the occasion of the MG 223.

In scenario 230, since a keep solution is granted for the collision between the occasion of the MUSIM gap 233 and the occasion of the MUSIM gap 235, the UE 110 first uses a priority solution for a collision associated with the occasion of the MG 231 for determining a non-dropped occasion. As the priority level of the MG 231 is higher than that of the MUSIM gap 233, the UE 110 determines the occasion of the MG 231 as the non-dropped occasion (i.e., the occasion of the MG 231 is kept and the occasion of the MUSIM gap 233 is dropped). Then, as the occasion of the MUSIM gap 235 is not colliding with the kept MG 231 occasion, the UE 110 determines the occasion of the MUSIM gap 235 as another non-dropped occasion, resulting in keeping the occasion of the MG 231 and the occasion of the MUSIM gap 235.

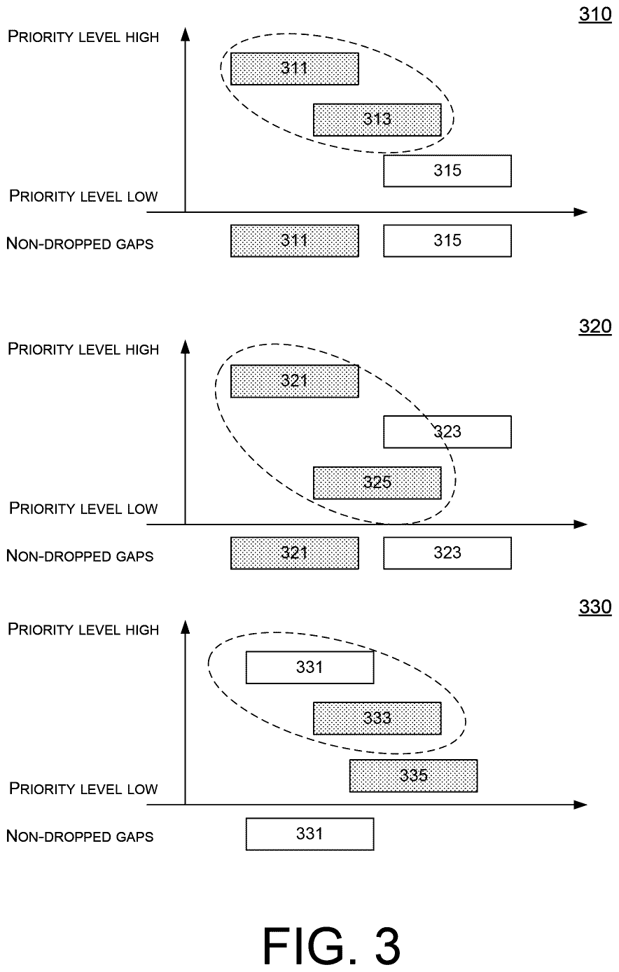

FIG. 3 is a diagram depicting example scenarios of collision handling in accordance with another embodiment of the present disclosure. In this embodiment, the UE 110 receives at least one configuration for two MUSIM gaps and one MG from the network A. The two MUSIM gap occasions and the MG occasion are colliding. In an event that the priority solution is granted for the collision between the two MUSIM gap occasions, the scenarios 310 to 330 show how the UE 110 perform a collision handling under the proposed scheme. To be specific, the UE 110 handles all collisions sequentially in order of decreasing priority and starting from a gap with a highest priority level regardless of the type of gap involved in the collision.

For example, in scenario 310, as the MUSIM gap 311 has the highest priority level, the occasion of the MUSIM gap 313 colliding with the occasion of the MUSIM gap 311 is dropped. Then, the non-dropped MUSIM gap 311 is compared with the remaining MG 315. The UE 110 determines that the occasion of the MG 315 as another non-dropped occasion since it is not colliding with the occasion of the MUSIM 311.

In scenario 320, as the MUSIM gap 321 has the highest priority level, the occasion of the MUSIM gap 325 colliding with the occasion of the MUSIM gap 321 is dropped. After that, the non-dropped MUSIM gap 321 is compared with the remaining MG 323. The UE 110 determines that the occasion of the MG 323 as another non-dropped occasion since it is not colliding with the occasion of the MUSIM 321.

In scenario 330, as the MG 331 has the highest priority level, the occasion of the MUSIM gap 333 colliding with the occasion of the MG 331 is dropped. Then, the non-dropped MG 331 is compared with the remaining MUSIM gap 335. As the occasion of the MUSIM gap 335 is colliding with the occasion of the MG 331, the UE 110 drops the occasion of the MUSIM gap 335, resulting in only keeping the occasion of the MG 331.

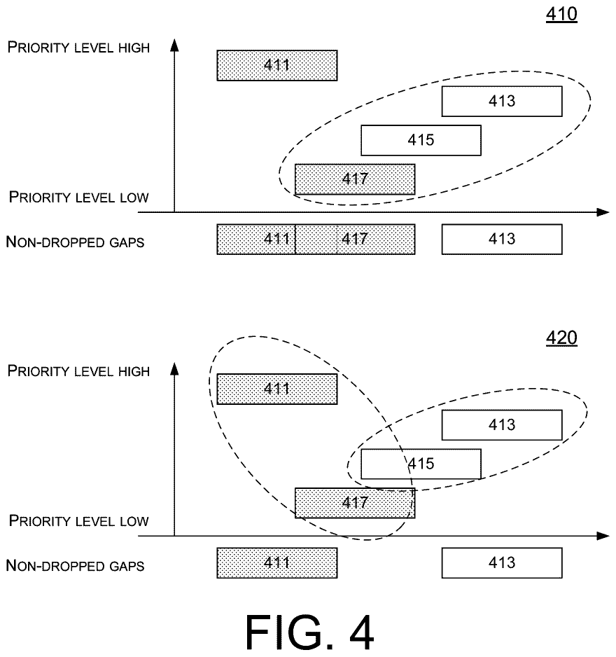

The foregoing embodiments take the collision involving two MUSIM gap occasions and one MG occasion as examples. However, the scope of the present disclosure is not limited thereto. FIG. 4 is a diagram depicting example scenarios of collision handling in accordance with still another embodiment of the present disclosure. In FIG. 4, the UE 110 receives at lease one configuration for two MUSIM gaps 411 and 417 and two MGs 413 and 415 from the network A. The priority level of each of the MUSIM gaps and the MGs is different and is configured by the network A.

In scenario 410, the keep solution is granted for the collision between the occasion of the MUSIM gap 411 and the occasion of the MUSIM gap 417. The UE 110 first uses the priority solution for the collision between the occasion of the MG 413, the occasion of the MG 415, and the occasion of the MUSIM gap 417. In this embodiment, the occasion of the MG 415 is dropped, and the occasion of the MG 413 and the occasion of the MUSIM gap 417 is kept. The UE 110 then use the keep solution for the collision between the occasion of the MUSIM gap 411 and the occasion of the MUSIM gap 417, resulting in keeping the occasion of the MUSIM gap 411, the occasion of the MUSIM gap 417, and the occasion of the MG 413. It should be noted that the keep solution will be applied between the occasions of the MUSIM gaps only after resolving other collisions based on priority solution. The example of other collisions could be between the occasion of the MUSIM gap and the occasion of the MG, or even between the occasion of the MG and the occasion of the MG.

In scenario 420, the priority solution is granted for the collision between the occasion of the MUSIM gap 411 and the occasion of the MUSIM gap 417. In this embodiment, all collisions are handled sequentially in order of decreasing priority and starting from the MUSIM gap 411 with the highest priority level. The occasion of the MUSIM gap 417 colliding with the occasion of the MUSIM gap 411 is dropped. The occasion of the MG 413 with the second highest priority level is kept as it is not colliding with the occasion of the MUSIM gap 411. The occasion of the MG 415 colliding with the occasion of the MG 413 is dropped. As a result, the UE 110 keep the occasion of the MUSIM gap 411 and the occasion of the MG 413 in this embodiment.

In the foregoing embodiments, the MG can be a Rel-17 concurrent MG with priority level configured via GapConfig-r17. However, the MG may also be a Pre-MG with priority level configured via preConfigInd-r17, or a Network Controlled Small Gap (NCSG) with priority level configured via ncsgInd-r17.

In some embodiments, the UE 110 may be configured with the gap(s) with no priority level. The UE 110 can handle the collision between the occasion of a MUSIM gap and the occasion of a gap without priority level based on the measurement gap repetition period (MGRP) of the colliding gaps. For example, in scenario 510, the UE 110 receives at least one configuration for MUSIM gaps 511 and 513, and MGs 522, 524, 526 and 528. For example, the MUSIM gaps 511 and 513 are configured via MUSIM-GapConfig-r17. In one example, the MGs 522, 524, 526 and 528 are configured via GapConfig or configured via GapConfig-r17 without assigned priority level. In another example, the MGs 522, 524, 526 and 528 may be Release 15 (Rel-15) and Release 16 (Rel-16) MG. Since shorter MGRP gap has more opportunities (occasions) than the larger MGRP gap, the collided gap which has larger MGRP should be kept and the one with shorter MGRP can be dropped. For example, the occasion of the MUSIM gap 511 and the occasion of the MG 522 are colliding. Under a proposed scheme, the UE 110 keeps the occasion of the MUSIM gap 511 as the MGPR_MUSIM is longer than the MGPR_MG. The collision between the occasion of the MUSIM gap 513 and the occasion of the MG 528 can be handled in a similar way.

### Illustrative Implementations

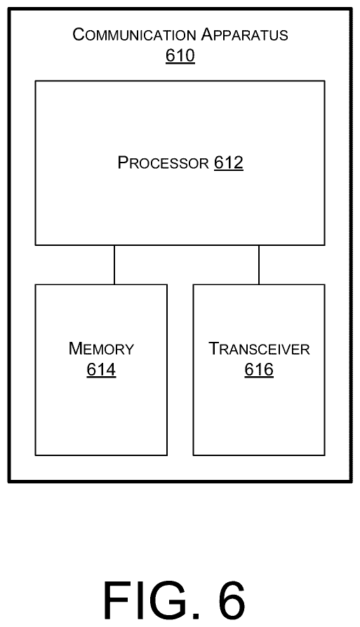

FIG. 6 illustrates an example communication apparatus 610 in accordance with an implementation of the present disclosure. The communication apparatus 610 may perform various functions to implement schemes, techniques, processes and methods described herein pertaining to collision handling for a MUSIM device in mobile communications, including scenarios/schemes described above as well as process 700 described below.

Communication apparatus 610 may be a part of an electronic apparatus, which may be a UE such as a portable or mobile apparatus, a wearable apparatus, a wireless communication apparatus or a computing apparatus. For instance, communication apparatus 610 may be implemented in a smartphone, a smartwatch, a personal digital assistant, a digital camera, or a computing equipment such as a tablet computer, a laptop computer or a notebook computer. Communication apparatus 610 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 610 may be implemented in a smart thermostat, a smart fridge, a smart door lock, a wireless speaker or a home control center. Alternatively, communication apparatus 610 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 610 may include at least some of those components shown in FIG. 6 such as a processor 612, for example. Communication apparatus 610 may further include one or more other components not pertinent to the proposed scheme of the present disclosure (e.g., internal power supply, display device and/or user interface device), and, thus, such component(s) of communication apparatus 610 are neither shown in FIG. 6 nor described below in the interest of simplicity and brevity.

In one aspect, processor 612 may be implemented in the form of one or more single-core processors, one or more multi-core processors, or one or more CISC processors. That is, even though a singular term “a processor” is used herein to refer to processor 612, processor 612 may include multiple processors in some implementations and a single processor in other implementations in accordance with the present disclosure. In another aspect, processor 612 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, processor 612 is a special-purpose machine specifically designed, arranged and configured to perform at least a part of the specific tasks including collision handling in a UE (e.g., as represented by communication apparatus 610) in accordance with various implementations of the present disclosure.

In some implementations, communication apparatus 610 may also include a transceiver 616 coupled to processor 612 and capable of wirelessly transmitting and receiving data. In some implementations, transceiver 616 may be capable of wirelessly communicating with different types of wireless networks of different radio access technologies (RATs). In some implementations, transceiver 616 may be equipped with a plurality of antenna ports (not shown) such as, for example, four antenna ports. That is, transceiver 616 may be equipped with multiple transmit antennas and multiple receive antennas for multiple-input multiple-output (MIMO) wireless communications.

In some implementations, communication apparatus 610 may further include a memory 614 coupled to processor 612 and capable of being accessed by processor 612 and storing data therein. Memory 614 may include a type of random-access memory (RAM) such as dynamic RAM (DRAM), static RAM (SRAM), thyristor RAM (T-RAM) and/or zero-capacitor RAM (Z-RAM). Alternatively, or additionally, memory 614 may include a type of read-only memory (ROM) such as mask ROM, programmable ROM (PROM), erasable programmable ROM (EPROM) and/or electrically erasable programmable ROM (EEPROM). Alternatively, or additionally, memory 614 may include a type of non-volatile random-access memory (NVRAM) such as flash memory, solid-state memory, ferroelectric RAM (FeRAM), magnetoresistive RAM (MRAM) and/or phase-change memory.

Communication apparatus 610 may be a communication entity capable of using various proposed schemes in accordance with the present disclosure. For illustrative purposes and without limitation, descriptions of capabilities of communication apparatus 610, implemented in or as a UE are provided below with process 700.

### Illustrative Processes

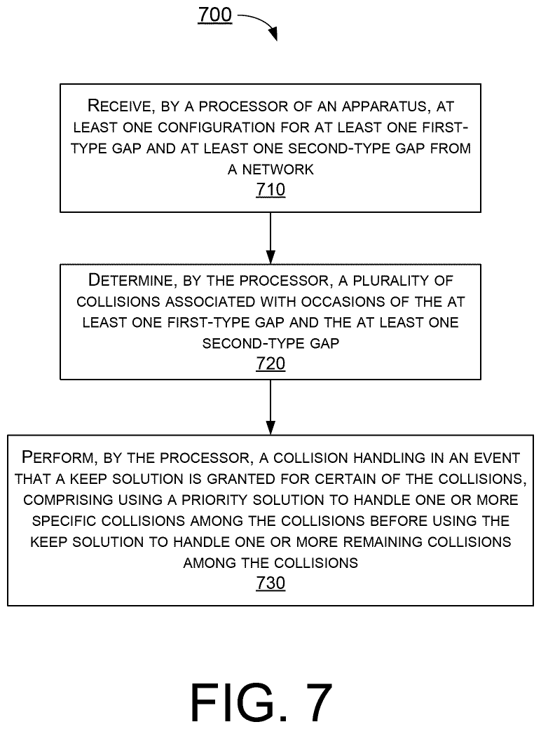

FIG. 7 illustrates an example process 700 in accordance with an implementation of the present disclosure. Process 700 may be an example implementation of above scenarios/schemes, whether partially or completely, with respect to collision handling for a MUSIM device in mobile communications. Process 700 may represent an aspect of implementation of features of communication apparatus 610. Process 700 may include one or more operations, actions, or functions as illustrated by one or more of blocks 710, 720, and 730. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by communication apparatus 610 or any suitable UE or machine type devices. Solely for illustrative purposes and without limitation, process 700 is described below in the context of communication apparatus 610 as a UE. Process 700 may begin at block 710.

At 710, process 700 may involve processor 612 of communication apparatus 610 receiving at least one configuration for at least one first-type gap and at least one second-type gap from a network (e.g., the network A). Process 700 may proceed from 710 to 720.

At 720, process 700 may involve processor 612 determining a plurality of collisions associated with occasions of the at least one first-type gap and the at least one second-type gap. Process 600 may proceed from 720 to 730.

At 730, process 700 may involve processor 612 performing a collision handling in an event that a keep solution is granted for certain of the collisions, comprising using a priority solution to handle one or more specific collisions among the collisions before using the keep solution to handle one or more remaining collisions among the collisions.

In some implementations, the at least one first-type gap comprises a first first-type gap and a second first-type gap, and the at least one second-type gap comprises a first second-type gap, and process 700 may further involve processor 612 using a priority solution for a collision associated with the occasion of the first second-type gap to determine a first non-dropped occasion (e.g., the occasion of the MUSIM gap 213 in scenario 210, the occasion of the MG 223 in scenario 220, the occasion of the MG 231 in scenario 230) in an event that a keep solution is granted for a collision between the occasion of the first first-type gap and the occasion of the second first-type gap, and using the keep solution for the collision between the occasion of the first first-type gap and the occasion of the second first-type gap in an event that the first non-dropped occasion is that of either the first first-type gap or the second first-type gap.

In some implementations, process 700 may further involve processor 612 determining one specific occasion among the occasion of the first first-type gap and the occasion of the second first-type gap that is not colliding with the occasion of the first second-type gap as a second non-dropped occasion (e.g., the occasion of the MUSIM gap 221 in scenario 220, the occasion of the MUSIM gap 235 in scenario 230) in an event that the first non-dropped occasion is that of the first second-type gap.

In some implementations, the collision associated with the occasion of the first second-type gap is also associated with a specific first-type gap. Process 700 may further involve processor 612 determining that the first non-dropped occasion is that of the first second-type gap in an event that the first second-type gap has a higher priority than that of the specific first-type gap. Additionally, process 700 may further involve processor 612 determining that the first non-dropped occasion is that of the specific first-type gap in an event that the specific first-type gap has a higher priority than that of the first second-type gap.

In some implementations, process 700 may further involve processor 612 handling all collisions sequentially in order of decreasing priority and starting from a gap with a highest priority level in an event that the priority solution is granted for the collision between the occasion of the first first-type gap and the occasion of the second first-type gap. The handling is, for example, performed regardless of a gap type (in an event that the priority solution is granted for the collision between the occasion of the first first-type gap and the occasion of the second first-type gap).

In some implementations, process 700 may further involve processor 612 comparing a gap associated with a third non-dropped occasion (e.g., the occasion of the MUSIM gap 311 in scenario 310, the occasion of the MUSIM gap 321 in scenario 320, the occasion of MG 331 in scenario 330) with a remaining gap (e.g., the MG 315 in scenario 310, the MG 323 in scenario 320, the MUSIM gap 335 in scenario 330). Additionally, process 700 may further involve processor 612 determining that an occasion of the remaining gap as a fourth non-dropped occasion in an event that the third non-dropped occasion and the occasion of the remaining gap are not colliding. Moreover, process 700 may further involve processor 612 dropping the occasion of the remaining gap in an event that the third non-dropped occasion and the occasion of the remaining gap are colliding.

In some implementations, each of the at least one first-type gap comprises a multiple-universal subscriber identity modules (MUSIM) gap, and each of the at least one second-type gap comprises a measurement gap (MG).

In some implementations, a priority level of each of the at least one first-type gap and the at least one second-type gap is configured by the network.

In some implementations, process 700 may further involve processor 612 receiving at least one configuration of a third first-type gap and a first third-type gap from the network, wherein the first third-type gap is configured without priority level. Moreover, process 700 may further involve processor 612 handling a collision between an occasion of the third first-type gap and an occasion of the first third-type gap based on a first MGRP associated with the third first-type gap (e.g., MGPR_MUSIM in scenario 510) and a second MGRP associated with the first third-type gap (e.g., MGPR_MG in scenario 510).

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, at least one configuration for at least one first-type gap and at least one second-type gap from a network;
determining, by the processor, a plurality of collisions associated with occasions of the at least one first-type gap and the at least one second-type gap; and
performing, by the processor, a collision handling in an event that a keep solution is granted for certain of the collisions, comprising:
using a priority solution to handle one or more specific collisions among the collisions before using the keep solution to handle one or more remaining collisions among the collisions.

2. The method of claim 1, wherein the at least one first-type gap comprises a first first-type gap and a second first-type gap, and the at least one second-type gap comprises a first second-type gap, the performing of the collision handling further comprises:
using a priority solution for a collision associated with the occasion of the first second-type gap to determine a first non-dropped occasion in an event that a keep solution is granted for a collision between the occasion of the first first-type gap and the occasion of the second first-type gap; and
using the keep solution for the collision between the occasion of the first first-type gap and the occasion of the second first-type gap in an event that the first non-dropped occasion is that of either the first first-type gap or the second first-type gap.

3. The method of claim 2, wherein the performing of the collision handling further comprises:
determining, by the processor, one specific occasion among the occasion of the first first-type gap and the occasion of the second first-type gap that is not colliding with the occasion of the first second-type gap as a second non-dropped occasion in an event that the first non-dropped occasion is that of the first second-type gap.

4. The method of claim 2, wherein the collision associated with the occasion of the first second-type gap is also associated with a specific first-type gap, and the using of the priority solution to determine the first non-dropped occasion further comprises:
determining that the first non-dropped occasion is that of the first second-type gap in an event that the first second-type gap has a higher priority than that of the specific first-type gap; and
determining that the first non-dropped occasion is that of the specific first-type gap in an event that the specific first-type gap has a higher priority than that of the first second-type gap.

5. The method of claim 2, wherein the performing of the collision handling further comprises:
handling, by the processor, all collisions sequentially in order of decreasing priority and starting from a gap with a highest priority level in an event that the priority solution is granted for the collision between the occasion of the first first-type gap and the occasion of the second first-type gap.

6. The method of claim 5, wherein the handling of all collisions sequentially in order of decreasing priority is performed regardless of a gap type in an event that the priority solution is granted for the collision between the occasion of the first first-type gap and the occasion of the second first-type gap.

7. The method of claim 6, wherein the handling of all collisions sequentially further comprises:
comparing, by the processor, a gap associated with a third non-dropped occasion with a remaining gap;
determining, by the processor, that an occasion of the remaining gap as a fourth non-dropped occasion in an event that the third non-dropped occasion and the occasion of the remaining gap are not colliding; and
dropping, by the processor, the occasion of the remaining gap in an event that the third non-dropped occasion and the occasion of the remaining gap are colliding.

8. The method of claim 1, wherein each of the at least one first-type gap comprises a multiple-universal subscriber identity modules (MUSIM) gap, and each of the at least one second-type gap comprises a measurement gap (MG).

9. The method of claim 1, wherein a priority level of each of the at least one first-type gap and the at least one second-type gap is configured by the network.

10. The method of claim 1, further comprising:
receiving, by the processor, at least one configuration of a third first-type gap and a first third-type gap from the network, wherein the first third-type gap is configured without priority level; and
handling, by the processor, a collision between an occasion of the third first-type gap and an occasion of the first third-type gap based on a first measurement gap repetition period (MGRP) associated with the third first-type gap and a second MGRP associated with the first third-type gap.

11. An apparatus, comprising:
a transceiver which, during operation, communicates wirelessly; and
a processor communicatively coupled to the transceiver such that, during operation, the processor performs operations comprising:
receiving, via the transceiver, at least one configuration for at least one first-type gap and at least one second-type gap from a network;
determining a plurality of collisions associated with occasions of the at least one first-type gap and the at least one second-type gap; and
performing a collision handling in an event that a keep solution is granted for certain of the collisions, comprising:
using a priority solution to handle one or more specific collisions among the collisions before using the keep solution to handle one or more remaining collisions among the collisions.

12. The apparatus of claim 11, wherein the at least one first-type gap comprises a first first-type gap and a second first-type gap, and the at least one second-type gap comprises a first second-type gap, and during operation, the processor further performs operations comprising:
using a priority solution for a collision associated with the occasion of the first second-type gap to determine a first non-dropped occasion in an event that a keep solution is granted for a collision between the occasion of the first first-type gap and the occasion of the second first-type gap; and
using the keep solution for the collision between the occasion of the first first-type gap and the occasion of the second first-type gap in an event that the first non-dropped occasion is that of either the first first-type gap or the second first-type gap.

13. The apparatus of claim 12, wherein, during operation, the processor further performs operations comprising:
determining one specific occasion among the occasion of the first first-type gap and the occasion of the second first-type gap that is not colliding with the occasion of the first second-type gap as a second non-dropped occasion in an event that the first non-dropped occasion is that of the first second-type gap.

14. The apparatus of claim 12, wherein the collision associated with the occasion of the first second-type gap is also associated with a specific first-type gap, and the processor further performs operations comprising:
determining that the first non-dropped occasion is that of the first second-type gap in an event that the first second-type gap has a higher priority than that of the specific first-type gap; and
determining that the first non-dropped occasion is that of the specific first-type gap in an event that the specific first-type gap has a higher priority than that of the first second-type gap.

15. The apparatus of claim 12, wherein, during operation, the processor further performs operations comprising:
handling all collisions sequentially in order of decreasing priority and starting from a gap with a highest priority level in an event that the priority solution is granted for the collision between the occasion of the first first-type gap and the occasion of the second first-type gap.

16. The apparatus of claim 15, wherein the handling of all collisions sequentially in order of decreasing priority is performed regardless of a gap type in an event that the priority solution is granted for the collision between the occasion of the first first-type gap and the occasion of the second first-type gap.

17. The apparatus of claim 16, wherein the processor further performs operations comprising:
comparing a gap associated with a third non-dropped occasion with a remaining gap;
determining that an occasion of the remaining gap as a fourth non-dropped occasion in an event that the third non-dropped occasion and the occasion of the remaining gap are not colliding; and
dropping the occasion of the remaining gap in an event that the third non-dropped occasion and the occasion of the remaining gap are colliding.

18. The apparatus of claim 11, wherein each of the at least one first-type gap comprises a multiple-universal subscriber identity modules (MUSIM) gap, and each of the at least one second-type gap comprises a measurement gap (MG).

19. The apparatus of claim 11, wherein a priority level of each of the at least one first-type gap and the at least one second-type gap is configured by the network.

20. The apparatus of claim 11, wherein, during operation, the processor further performs operations comprising:
receiving, via the transceiver, at least one configuration of a third first-type gap and a first third-type gap from the network, wherein the first third-type gap is configured without priority level; and
handling, by the processor, a collision between an occasion of the third first-type gap and an occasion of the first third-type gap based on a first measurement gap repetition period (MGRP) associated with the third first-type gap and a second MGRP associated with the first third-type gap.
